(19) United States
(12) Patent Application Publication
(10) Pub. No.: US 2004/0145566 A1
(43) Pub. Date: Jul. 29, 2004

(54) Mouse with liquid decoration

(76) Inventor: Jui-An Tsai, Tao Yuan Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/342,287

(22) Filed: Jan. 15, 2003

(51) Int. Cl. G09G 5/08

(52) U.S. Cl. 345/163

(57) ABSTRACT

A mouse for computer has a transparent casing containing one or two types of liquid and/or floating ornaments and connected to a rear portion of the mouse on where an operator's hand is normally rested. The transparent casing is provided at a lower edge of an inner side thereof with a lug having a central through hole, such that the lug is located and firmly held between locking post and cylinder provided on upper and lower cases of the mouse by a fastening screw extended through the locking post and cylinder as well as the central hole of the lug, enabling the transparent casing to assemble to the upper and lower cases of the mouse in a simple and stable manner. Printed pictures or words or designs may be attached to the transparent casing at suitable places to serve as backgrounds of the floating ornaments or as an advertisement.

### BACKGROUND OF THE INVENTION

The present invention relates to a mouse with liquid decoration. The liquid decoration includes a transparent casing having one or two types of liquid and different floating ornaments contained therein. The transparent casing is provided at a lower edge of an inner side there of with a lug having a central through hole, such that the lug is located and firmly held between locking post and cylinder provided on upper and lower cases of the mouse by a fastening screw extended through the locking post and cylinder as well as the central hole of the lug, so that the transparent casing is easily and stably assembled to the upper and lower cases of the mouse.

The mouse is a peripheral necessary for operating a computer system. As a result of fierce competition in the market, the currently available mouse often includes many decorative designs in addition to its intended functions. For example, the mouse may have a clear upper case and a plurality of light-emitting diodes provided at a rear end for emitting different color lights, so that the mouse emits light when it is operated to send signals to a computer connected thereto. Alternatively, the mouse may have a transparent casing connected to a rear portion thereof for showing different liquids and/or ornaments statically or dynamically contained in the transparent casing. Such transparent casing with liquid and/or ornaments has been widely used for connecting to various kinds of bathroom items, such as tooth mugs, milky lotion bottles, toothbrush holders, brushes, mirror stands, mirrors, and hair brushes and combs, as well as to various kinds of stationery items, such as penholders, pens, pencil cases, paperweights, and memo holders. Other articles commonly seen in our daily life, such as watches, clocks, mobile phone stands, and pendants for mobile phone, may also be provided with such liquid decoration. Therefore, the provision of a liquid decoration having a transparent casing and liquid and floating ornaments on an article, including the mouse, is simply a decorative design without substantial features. That is, the provision of the liquid decoration to an article is not an inventive step.

Chinese New Design Patent Application No. 00306445.X entitled “Mouse” filed on Apr. 24, 2000 discloses an ornamental design for a mouse having a liquid decoration. Chinese New Utility Model Patent Applications Nos. 00250064.6 entitled “Mouse” filed on Sep. 4, 2000 and 00254456.3 entitled “Mouse with Decorative Means” filed on Sep. 30, 2000, and U.S. Pat. No. 6,380,926B1 entitled “Computer Mouse” filed on Oct. 10, 2000 also disclose similar mouse after the Chinese New Design Patent Application No. 00306445.X has been filed. Theoretically speaking, the above-mentioned two Chinese New Utility Model Patent applications and the U.S. Pat. No. 6,380,926B1 are not novel or inventive, and are supposed to be invalid patents.

Moreover, in the above-mentioned patent and patent applications, the liquid decorations are connected to the mice by way of supersonic welding, gluing, or halved joint. To implement these conventional ways of connection, either a corresponding connection structure, such as supersonic welding line or groove and tongue, must be provided on the mouse, or an additional manufacturing process, such as applying glue, must be included. All these additional connection structure and process result in increased manufacturing cost. Moreover, since the mouse and the liquid decoration belong to two different technical fields and are produced by different manufacturers, there are difficulties in designing the structure for perfectly and conveniently connecting the mouse and the liquid decoration to each other without causing troubles in management of manufacturing process thereof. For example, the mouse manufacturer might not be skilled in supersonic welding, gluing, or halves joint to successfully assemble the liquid decoration to mouse in the case the finished liquid decorations are delivered to the mouse manufacturer. Reversely, the liquid decoration manufacturer might very possibly carelessly damage the mouse during assembling the liquid decoration to the mouse, in the case the finished mice are delivered to the liquid decoration manufacturer for final assembling. And, the liquid decoration manufacturer is not in the position to test and warrant the quality of the finally assembled mice.

It is therefore tried by the inventor to develop a new way to overcome the above-mentioned problems existed in the assembling of the liquid decoration to the mouse.

### SUMMARY OF THE INVENTION

A primary object of the present invention is to provide a mouse with liquid decoration, in which a transparent casing of the liquid decoration can be easily and stably connected to the mouse through a lug provided at a lower edge of an inner side of the liquid decoration. The lug has a central through hole and is located and firmly held between locking post and cylinder provided on upper and lower cases of the mouse by a fastening screw extended through the locking post and cylinder as well as the central hole of the lug, enabling the whole liquid decoration to connect to a rear portion of the mouse in a simple and stable manner.

Another object of the present invention is to provide a mouse with liquid decoration as described in the above paragraph, wherein printed pictures or words or designs may be attached to outer surface of the inner or the bottom side of the transparent casing to serve as a background of ornaments in the casing or as an advertisement.

A further object of the present invention is to provide a mouse with liquid decoration as described in the above paragraphs, wherein the transparent casing may be provided on its outer side with outward curved areas to change the contour of the liquid decoration without adversely affecting the comfortableness in handling the mouse.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a mouse with liquid decoration according to the present invention;

FIG. 2 is an exploded perspective view of the mouse of FIG. 1;

FIG. 3 is a partially sectioned side view of the mouse of FIG. 1 showing the manner of assembling the liquid decoration to the mouse;

FIG. 4 is an exploded perspective view of the mouse of the present invention with background pictures provided along with the liquid decoration;

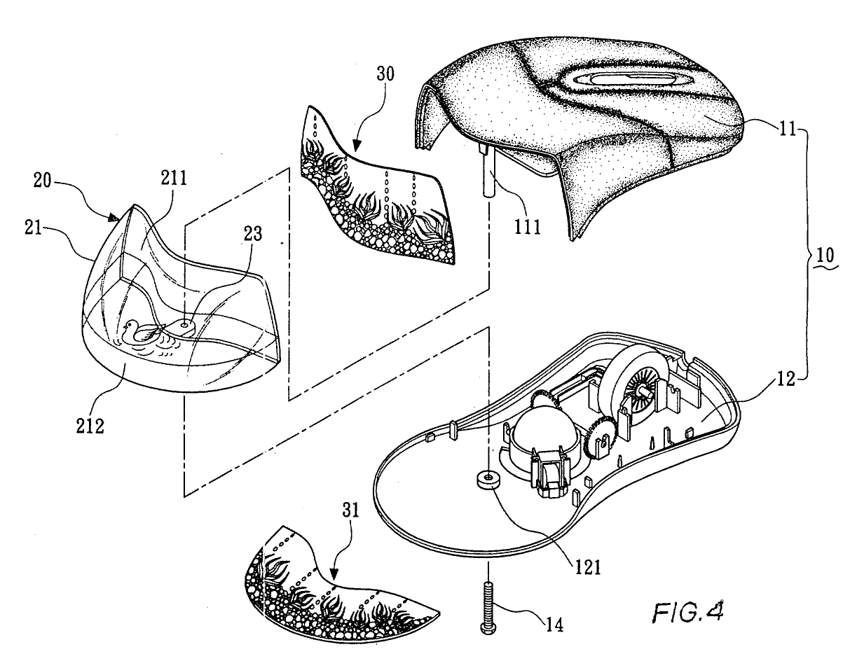

FIG. 5 is an assembled perspective view of the mouse of FIG. 4;

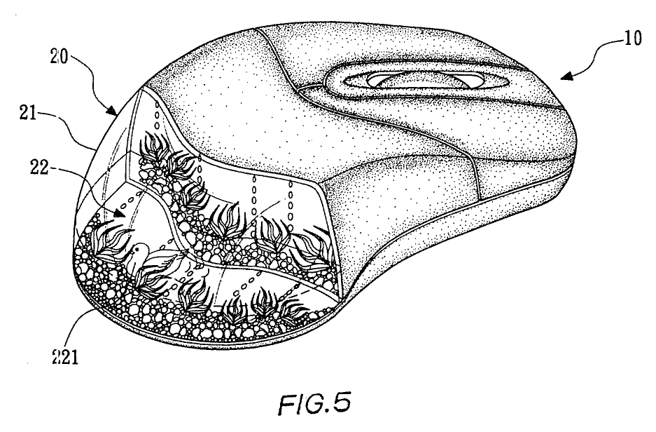

FIG. 6 is a perspective view of a mouse with liquid decoration according to another embodiment of the present invention; and

FIG. 7 is a perspective view of a mouse with liquid decoration according to a further embodiment of the present invention.

### DETAILED DESCRIPTION OF THE PREFERRED EMBODIMENTS

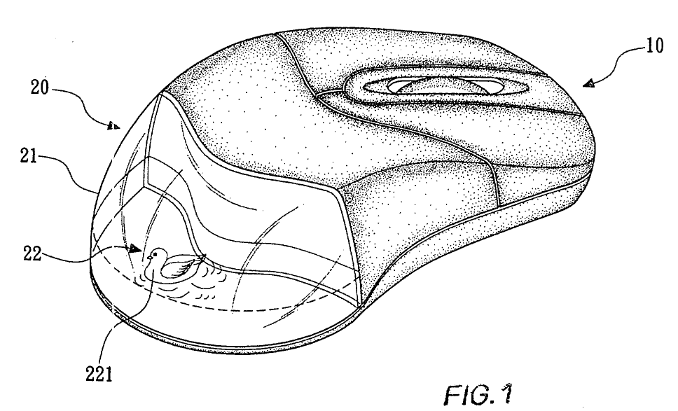

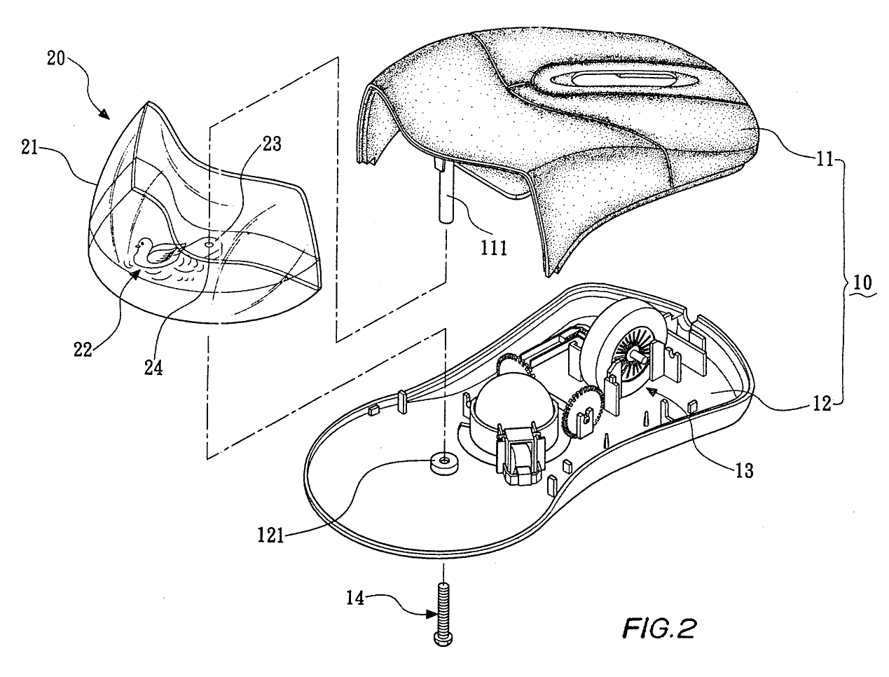

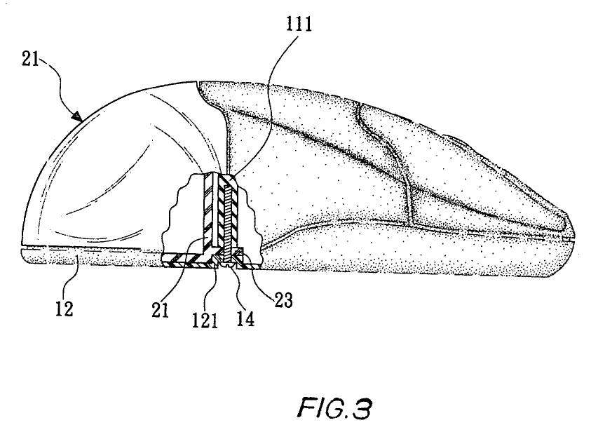

Please refer to FIGS. 1, 2 and 3 at the same time, in which a mouse with liquid decoration according to a preferred embodiment of the present invention is shown. The mouse, which is generally denoted with a reference numeral 10, mainly includes an upper case 11, a lower case 12, and various internal electronic components 13. The upper case 11 and the lower case 12 are connected to each other by a fastening screw 14 upward extended from a bottom of the mouse 10 through a lower cylinder 121 on the lower case 12 into an elongate hollow post 111 on the upper case 11. Both the elongate hollow post 111 and the lower cylinder 121 are located in the mouse 10 close to a rear portion thereof, at where an internal hollow space is usually formed, and above where a user's hand is normally rested for operating the mouse 10. With the above arrangements, it is possible to cut off the rearmost part of the upper case 11 and substitute the cut-off part with a liquid decoration 20 without affecting the intended function of the mouse 10. Since there are various methods and technical means that have been widely adopted to cut off a part of an article to provide a receiving space thereon, the provision of a liquid decoration 20 on the mouse 10 by cutting off the rear portion of the upper case 11 is basically not an inventive or a practical step. The liquid decoration 20 consists of a transparent casing 21 and some ornaments 22 contained in the casing 21. While the transparent casing 21 may be of any shape, it preferably has a configuration matching with the rear portion of the mouse 10, so that the mouse 10 can be operated as convenient as any other normal mouse. The ornaments 22 contained in the casing 21 may include one or two types of liquid (including oil and tinted water) and differently shaped floating articles 221. In the illustrated drawings, there is an ornamental duck floating over an interface between two types of liquids. It is also found in the market a liquid decoration containing one type of liquid and an eccentric spherical ornament like an eyeball, so that the spherical ornament rotates in the liquid like a tumbler when the mouse is moved during operation.

The present invention is characterized in that the transparent casing 21 includes a lug 23 projected from a predetermined position at a lower edge of an inner side 211 of the casing 21, such that the lug 23 is located between the elongate hollow post 111 and the lower cylinder 121 already provided in the mouse 10. Moreover, the lug 23 is formed of a central through hole 24 to align with the elongate hollow post 111 and the lower cylinder 121. Whereby when the fastening screw 14 is extended through the lower cylinder 121 and the elongate hollow post 111 to lock the upper and the lower case 11, 12 together, it also extends through the central hole 24 on the lug 23 to hold the lug 23 in place between the post 111 and the cylinder 121, enabling the transparent casing 21 of the liquid decoration 20 to firmly assemble to the rear portion of the mouse 10. Since the liquid decoration 20 is assembled to the mouse 10 in a largely simplified manner without using supersonic welding, gluing, or halved joint, which are often used in replacing something with another one, it is possible to mass-produce the mouse with liquid decoration under strict production control.

The liquid decoration 20 may also have printed pictures 30, 31 attached to outer surfaces of inner and bottom sides 211, 212 of the transparent casing 21 to form different backgrounds for the ornaments 22 in the transparent casing 21. For example, in the illustrated drawings, the printed pictures 30, 31 show water plant and pond to match with the duck. Or alternatively, the printed pictures may show other designs, such as trademark devices, to serve as an advertisement. The printed pictures therefore enable the liquid decoration 20 to provide good decorative and advertising effect in a rather simple manner.

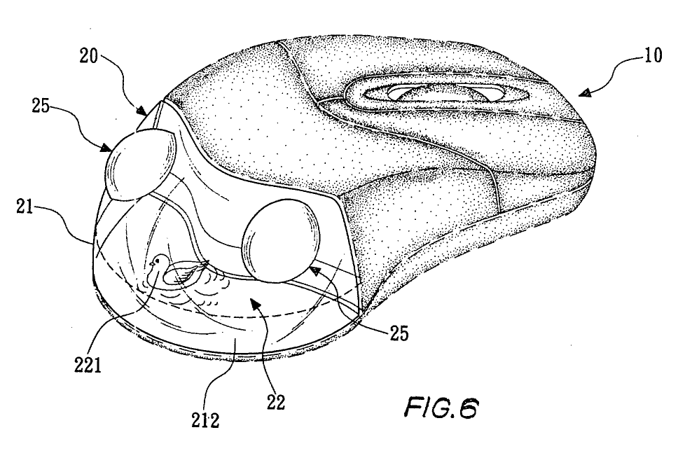

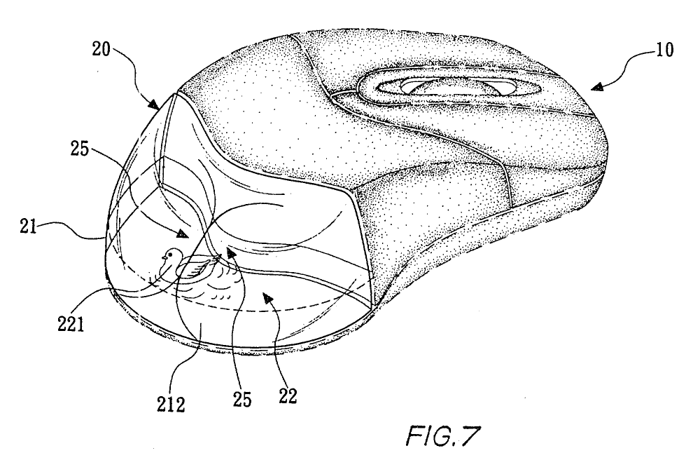

While the liquid decoration 20 is preferably in a configuration matching with the general shape for the rear portion of the mouse 10, many changes may still be made to an outer side of the transparent casing 21 to make the mouse more interesting without adversely affecting the operation thereof. For example, FIG. 6 shows a transparent casing 21 having two semispherical protrusions 25 symmetrically provided at two upper corners thereof, making the liquid decoration 20 looked like a frog head. And, FIG. 7 shows a transparent casing 21 having two laterally symmetrical curved protrusions 25 with a depressed central area, making the liquid decoration 20 looked like two hips. These changes in the configuration of the transparent casing 21 also increase the decorative function of the mouse 10.

What is claimed is:

1. A mouse with liquid decoration, comprising an operational portion and a liquid decoration portion; said operational portion including an upper case, a lower case, and various internal electronic components; said upper case and lower case being connected to each other by a fastening screw upward extended from a bottom of said mouse through a lower cylinder formed close to a rear side of the lower case, into an elongate hollow post formed on the upper case corresponding to said lower cylinder; said liquid decoration portion including a transparent casing and some ornaments contained in said transparent casing, and being located at a rear hollow space of said operational portion behind said lower cylinder and said elongate hollow post without affecting an intended function of said mouse; said mouse with liquid decoration being characterized in that said liquid decoration portion has a lug projected from a lower edge of an inner side of said transparent casing into said operational portion to locate between said elongate hollow post and said lower cylinder, and provided with a central through hole corresponding to and aligned with said elongate hollow post and said lower cylinder; whereby when said fastening screw is extended through said lower cylinder into said elongate hollow post to assemble said lower case to said upper case, said fastening screw also extends through said central hole on said lug to hold said lug in place between said elongate hollow post and said lower cylinder and thereby firmly connects said liquid decoration portion to the rear hollow space of said operational portion.

2. The mouse with liquid decoration as claimed in claim 1, wherein said transparent casing of said liquid decoration portion is provided at an outer surfaces of an inner side and a bottom side with printed pictures to form backgrounds for said ornaments contained in said transparent casing.

3. The mouse with liquid decoration as claimed in claim 1, wherein said transparent casing of said liquid decoration portion is provided with smoothly curved areas to create changes in an appearance of said transparent casing.
